(19) United States
(12) Patent Application Publication
(10) Pub. No.: US 2018/0200850 A1
(43) Pub. Date: Jul. 19, 2018

(54) SYSTEM AND METHOD FOR A CONFIGURABLE INDUSTRIAL MACHINE

(71) Applicant: Kugar Inc., San Francisco, CA (US)

(72) Inventor: Gary Stanley Kurek, San Francisco, CA (US)

(21) Appl. No.: 15/874,888

(22) Filed: Jan. 19, 2018

Related U.S. Application Data
(60) Provisional application No. 62/448,290, filed on Jan. 19, 2017.

(51) Int. Cl. B23Q 1/01; B23B 47/00

(52) U.S. Cl. CPC B23Q 1/015; B23B 2270/16; B23B 47/00

(57) ABSTRACT

A system and method for a configurable machine bed that includes a set of modular blocks, wherein each module block comprises a defined longitudinal extrusion cavity and a set of coupling interfaces; wherein in a first assembled configuration, at least two modular blocks are rigidly coupled at opposing coupling interfaces of the at least two modular blocks; and optionally including a machine tooling element coupled to at least one modular block.

### CROSS-REFERENCE TO RELATED APPLICATIONS

This Application claims the benefit of U.S. Provisional Application No. 62/448,290, filed on 19 Jan. 2017, which is incorporated in its entirety by this reference.

### TECHNICAL FIELD

This invention relates generally to the field of industrial machines, and more specifically to a new and useful system and method for a configurable industrial machine.

### BACKGROUND

Industrial manufacturing tools such as CNC machines, mills, lathes, and other manufacturing tools are used to build nearly all modern products. These manufacturing tools are often designed using a heavy casting as a base. There is a preconceived notion that the structure of a manufacturing tool needs to be very heavy and very rigid to deal with the extreme forces and stress encountered during various manufacturing processes. A manufacturing tool may use one solid cast metal base that weighs several tons. One problem with manufacturing tools being heavy and large is that setting up a factory or machine shop with manufacturing tools can be expensive and slow. Additionally, because of the difficulty in transporting and setting up a manufacturing tool, the manufacturing tools are often thought of as substantially static fixtures once moved into place. This approach to building and designing manufacturing tools has been continued from the industrial era into modern times and is assumed as a basic tenant to manufacturing tools by many experts and manufacturers. With machining tools keeping with old approaches and designs, industrial machines are largely inflexible and designed around general purpose tasks. Thus, there is a need in the industrial machine field to create a new and useful system and method for a configurable industrial machines. This invention provides such a new and useful system and method.

### BRIEF DESCRIPTION OF THE FIGURES

FIG. 1 is a schematic representation of an assembled block structure;

FIG. 2 is a schematic representation of a modular block;

FIG. 3 is a schematic representation of an assembled block structure with coupled machine tooling elements;

FIGS. 4A-4C are schematic representations of exemplary types of modular blocks;

FIGS. 5A-5C are schematic representations of exemplary alternative modular block forms;

FIGS. 6A and 6B are schematic representations with exemplary dimensions of a modular block;

FIGS. 7A-7D are schematic representations of exemplary variations of modular block configuration approaches;

FIG. 8 is a schematic representation of staggered aligned blocks;

FIG. 9 is a schematic representation of four coupled modular blocks with diamond configuration of the defined longitudinal cavities;

FIG. 10 is a schematic representation of a modular block with bolts and t-nut;

FIG. 11 is a schematic representation of a t-nut;

FIG. 12 is an exploded schematic representation of the components of the system that can be used to attach two adjacent modular blocks;

FIGS. 13A and 13B are schematic representations of a bracing member coupling interface used with a set of bracing members;

FIGS. 14A-14C are schematic representations of the system used with exemplary pieces of machine tooling; and

FIG. 15 is a flowchart representation of a method of a preferred embodiment.

### DESCRIPTION OF THE EMBODIMENTS

The following description of the embodiments of the invention is not intended to limit the invention to these embodiments but rather to enable a person skilled in the art to make and use this invention.

### Overview

A system and method for a configurable industrial machine of a preferred embodiment functions to enable the customized construction of different rigid structures that are applicable to industrial and manufacturing applications. The system and method enable the use of specialized modular blocks that can be coupled together in an arrangement to form a base on which various machining tools, manufacturing and industrial machines, and/or other pieces of equipment can be attached. This can be used in place of and/or in connection to a casting.

In manufacturing, machine tools generally depend in part on having a stable base on which to operate. The system can function to enable a bed for a machine tool to be constructed from a plurality of components. As one discovery of the inventors, contrary to traditional and long entrenched approaches, a solid cast metal bed could be replaced by lighter, cheaper, and more customizable components. The system can be used for machine tools such as a CNC (computer numerical control) machine, which is a rigorous and demanding tool that deals with high forces, considerable vibration, and high precision requirements.

The system and method can be used and configured to act as the industrial structure for various types of industrial tools. The industrial tools may be used for manufacturing and in some preferred applications machining. The system and method could be used with various types of industrial elements such as subtractive machining elements (e.g., milling, lathes, drill presses, etc.), additive manufacturing systems (e.g., injection molding machines, etc.), material forming (e.g., brakes, stamping, etc.), material handling (e.g., conveyors, robotic manipulators, etc.), and/or other suitable applications. For example, the system and method can be used to create a multi-axis CNC machine, a manual vertical or horizontal mill, a lathe, an extrusion machine, an injection molding device, a plotter tooling element, and/or other forms of manufacturing machines. The system may additionally or alternatively be applied to any suitable industrial application that may benefit from structural performance of a rigid structure capable of handling high forces, vibrations, and/or other forms of structural stress. For example, the system and method may be used in constructing frames, structures, gantries, structures for logistics or warehousing, and/or other applications. For example, the system could additionally be used for other industrial or manufacturing structures such as a conveyor-belt, industrial robots, electronic manufacturing, fabrication processes, and/or any suitable application.

While the system can be configured as a bed for a traditional machine, the ease of configuration can open up new machine categories that traditionally have not been available because of the high cost and commitment to a casted bed. For example, highly customized machine beds could be created to support a customized manufacturing process for a product. In one example, multiple machine tool elements could be coupled to the same configured block structure to provide customized machining and/or processing capabilities.

As one potential benefit, the system can offer customization of a configured block structure. Preferably, this ability of variable configuration enables application of the system and method to a variety of industrial and manufacturing machine types as described above. As a first enabling aspect, the modular blocks can be attached in a variety of ways. The modular blocks include multiple coupling face options that can enable a variety of ways in which adjacent modular blocks can be rigidly connected. Preferably, the modular blocks can be aligned in different configurations along at least two axes, but may additionally allow variability in a variety of axis. As another enabling aspect, the modular blocks and other components of the system may be designed for ease of use. The modular blocks are preferably individually movable by a worker and/or pair of workers. The size and weight in some implementations can be designed to accommodate lifting and arranging by a worker. The modular blocks may alternatively be designed for use with moving device like a forklift, hoist, crane, or other suitable machine.

As a related potential benefit, the system can offer reconfigurability. The elements of a configured block arrangement could be rearranged to accommodate different arrangements. Similarly, components of the system could be repurposed for other configured block structures.

As another potential benefit, the ability to alter configuration can enhance the feasibility for building customized machining or manufacturing systems that use alternative or specialized base structures.

As another potential benefit, the system can provide a simplified setup process. Someone wanting to setup a machine shop could easily have the system transported to the site for setting up a machining bed. Depending on the bed properties, the system could be split into multiple shipments or be transported in any suitable manner. With the elements on site, the individual elements could be easily moved into positioned and quickly assembled. Traditional cast beds are labor intensive to transport and require heavy machinery to move. In one variation, the components could be made to be individually manipulated by a human worker. The elements of the system could be feasibly lifted and moved by an individual worker with no assistance or alternatively moved more quickly using basic assistance such as a dolly or forklift.

As another potential benefit, the system could be more cost effective. Since the system is composed of substantially modular elements, they may be made more cheaply. Mass production of the components could support a wide variety of machine tools. In one embodiment the blocks can be made of extruded aluminum, which can enable efficient manufacturing.

### System

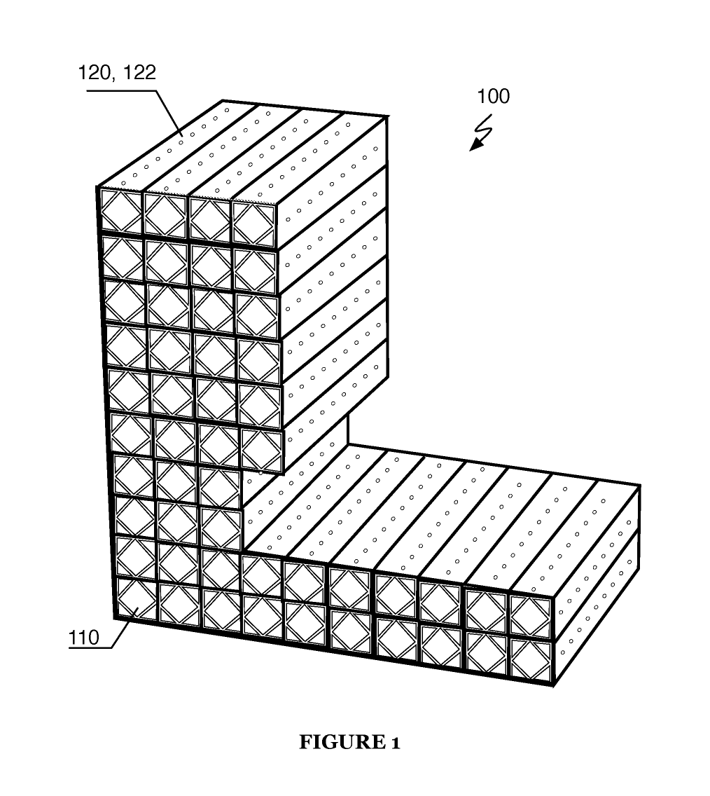

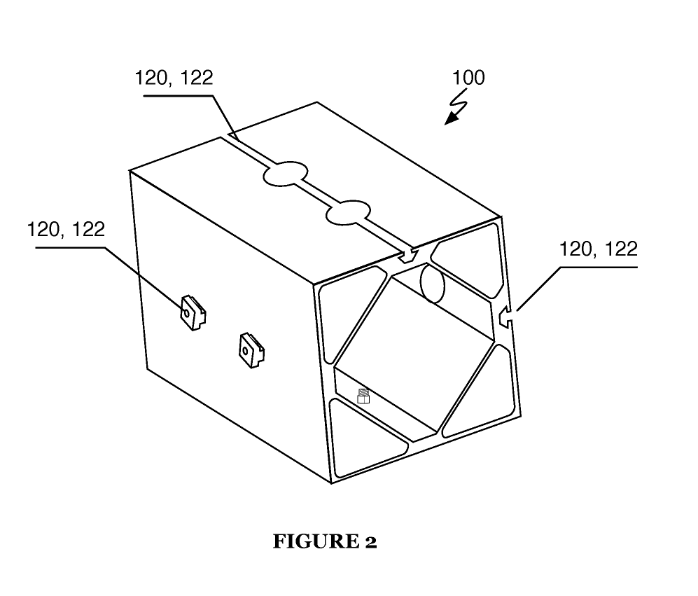

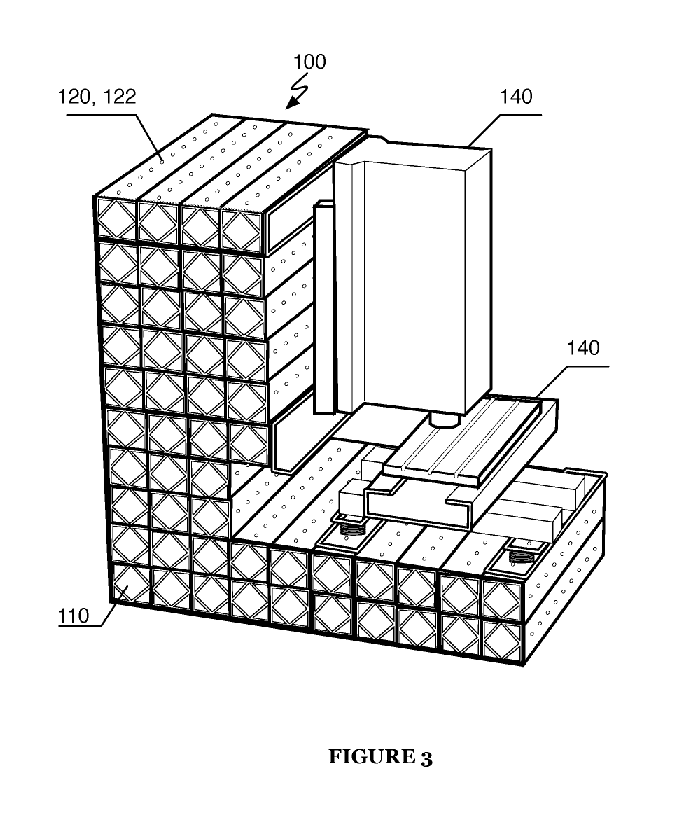

As shown in FIG. 1, a system for a configurable industrial machine of a preferred embodiment can include a set of modular blocks 100. Each modular block 100 may include a set of defined longitudinal extrusions 110 and a set of coupling interfaces 120 as shown in FIG. 2. An industrial manufacturing system built through the system preferably includes the modular blocks in at least one assembled block configuration that includes at least two modular blocks rigidly coupled at opposing coupling interfaces of the at least two modular blocks. More preferably a set of greater than two modular blocks (e.g., eight or more) are arranged in an aligned grid and rigidly attached at coupling interfaces of adjacent modular blocks. The system can be used to construct larger block structures in different arrangements. The system may additionally include a set of bracing members 130 that latch to a subset of modular blocks 100 that are used in a configured block structure and physically couple at least a subset of modular blocks 100. The system is preferably applied in the construction and usage of structures used in manufacturing and industrial settings as described above. More particularly, the modular blocks 100 are used in acting as the structural bodies in industrial machines. The system can additionally include one or more machine tooling elements 140 that can be physically coupled to a configured block structure in a rigid manner where the block structure acts as a base as shown in FIG. 3. As used herein, a configured block structure describes the resulting structure and arrangement when elements of the system are connected, which may be used to support some machine tooling functionality. Various geometric forms can be created by stacking and arranging the set of modular blocks 100, which can enable the system to be used for a wide variety of machine tooling applications. Machine tooling elements 140 can be used in building CNC milling machines, vertical or horizontal mills, lathes, an injection molding machines, extrusion machines, material forming manufacturing systems (e.g., brakes), material handlers (e.g., conveyors and robotic manipulators), multi-axis machining centers, and/or any suitable type of machine tooling used for industrial machines for manufacturing, assembly, or other applications.

A modular block 100 functions as a core building component providing the form and structural support when used in a configured block structure. The shape, profile, material, and/or other properties are preferably configured to serve the demanding operating conditions of a base structure used for manufacturing machines. The modular block 100 preferably includes geometric features that promote connecting other components while also addressing ease of manipulation (e.g., weight and assembly) and manufacturing. In particular, a modular block 100 can include a set of defined longitudinal extrusions 110 and a set of coupling interfaces 120.

The modular blocks 100 are preferably provided and used as a set. The set of modular blocks 100 functions to act as the main structural building blocks when constructing a configured block structure. Modular blocks 100 can be arranged and/or connected to form different shapes. These different shapes can accommodate different machines enabling different machine tooling elements 140 to be mounted in different positions and simultaneously providing structural support.

A number of modular blocks 100 (e.g., preferably greater than 10 blocks but at least two) can be used in combination in forming the configured block structure. Two or more modular blocks 100 can be physically coupled through the block coupling interfaces 122 exposed on one or more side faces. Optionally a bracing member 130 can physically couple at least two blocks by attaching at bracing member coupling interfaces 120.

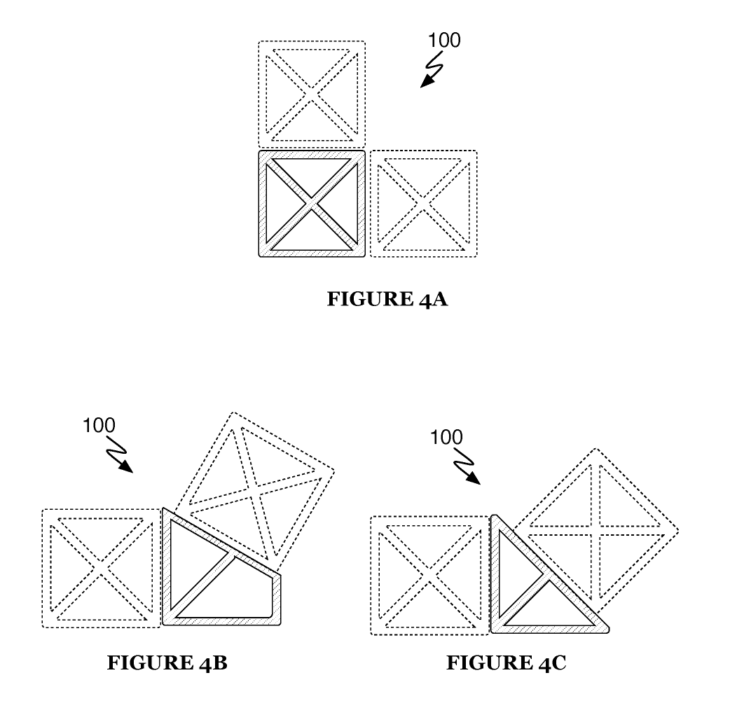

The set of modular blocks 100 in one implementation is preferably a set of substantially uniform modular blocks 100, wherein each modular block 100 is substantially the same shape and size. Alternatively, the set of modular blocks 100 can include at least two varieties of different types of modular blocks 100. The different types of modular blocks 100 can include size variations, profile variations, and/or other suitable variations. Size variations may be used wherein large and small blocks are arranged and connected in combination to form different structures. Profile variations may include different shape profiles that can be used to form different structural features. The set of modular blocks 100 preferably includes a subset of regular modular blocks 100 with a shape profile configured for regular grid-like arrangement as shown in FIG. 4A. The set of modular blocks 100 may additionally include a set of angled modular blocks 100 with a shape profile configured to enable modular blocks 100 to be mounted in non regular angles as shown in FIGS. 4B and 4C. For example, a first subset of modular blocks 100 could be cubes, a second subset of modular blocks 100 could be longer rectangular prisms, and a third subset of modular blocks 100 could be right triangular prisms.

In one preferred implementation, the modular blocks 100 are substantially rectangular prisms made from extruded material (e.g., aluminum) with at least one internal defined longitudinal cavity. More preferably, the extruded material includes a plurality of defined longitudinal cavities. More preferably, the modular blocks 100 include a set of defined internal longitudinal cavities with a set of block coupling interfaces 122 on the side faces (e.g., the four side faces in a rectangular prism modular block) and a set of bracing member coupling interfaces 124 on the two extruded faces.

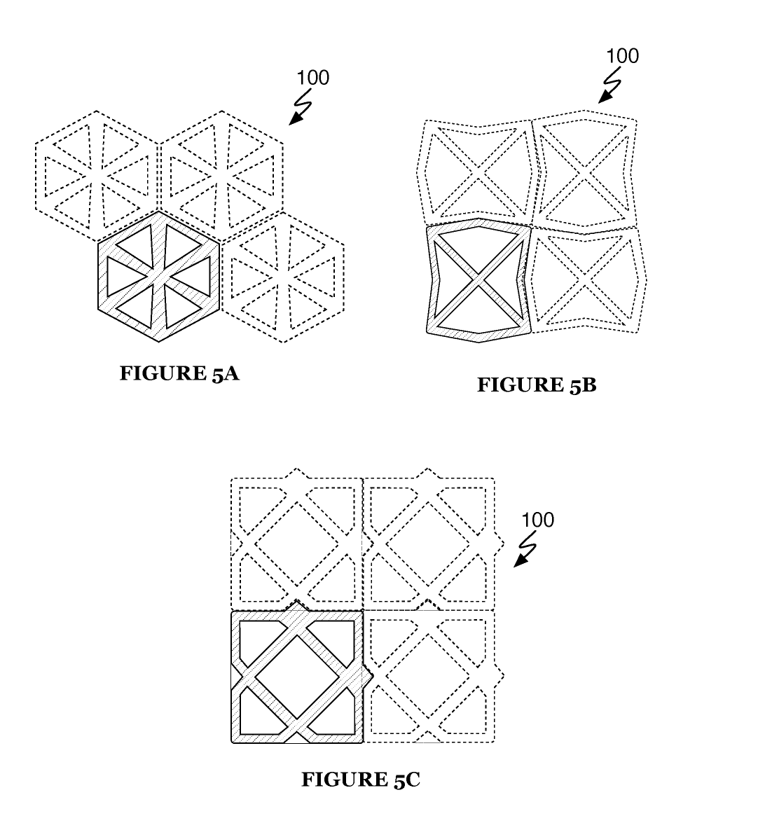

A rectangular prism can include a rhombic prism, a cube, a long rectangular prism or any suitable type of rectangular prism. Alternative forms such as a triangular prism or hexagonal prism (as shown in FIG. 5A) or other geometric forms may alternatively define the outer form of a modular block 100. Additionally, the general shape profile (rectangular, triangular, hexagonal, etc.) may include additional features like notches, rounded corners, and the like. The shape of the modular block 100 may be a regular symmetrical shape profile, but could alternatively be a non-regular shape and/or asymmetrical. Herein, the rectangular geometry is used as the primary example but is not meant to limit the modular blocks 100 to that geometry.

The length of a modular block 100 (herein defined as the dimension parallel to the direction of extrusion) is preferably at least the same as the width and height (e.g., herein width and height are defined as perpendicular dimensions of a defined bounding box around the extruded face), though the length may be less than the width or height in some variations. In one implementation, the length is twice that of the width and height. The width and height in another implementation are the same, but the width and height and width can alternatively be different sizes. In one particular implementation, the width and height are eight inches but may alternatively be sized between six inches and twelve inches and the length is thirty-two inches but could alternatively be sized between one twelve and forty-eight inches or any suitable size. Some variations could alternatively be larger or smaller

The modular blocks 100 are preferably aluminum. In one implementation, the material of the modular blocks 100 comprises 20-40% aluminum. Aluminum, aluminum alloys, and/or other suitably extruded materials can offer ease of manufacturing and structural integrity for the intended purposes. Additionally, the manufacturing process can be based around an extrusion process as opposed to a casting process. The extrusion profile at least in part can form the defined internal longitudinal extrusion cavities. An extruded modular block may additionally include a set of machined fastening features such as defined bolt through-holes and the like on the coupling features and/or other features machined as a secondary manufacturing process.

Other suitable materials, alloys, composites, or combinations of materials may alternatively be used. In one example, a carbon fiber material can be used. In another steel or other materials may be used. A modular block 100 is preferably formed from a single piece of manufactured material. The modular block 100 may alternatively be constructed of multiple parts that are combined or constructed to form the modular block 100. For example, a steel modular block could be formed through the welding and machining of multiple steel plates.

Preferably, the dimensions and/or material of the modular block 100 can be designed so that the weight of an individual block is movable by worker or a suitable device. In one variation, the weight of an individual block is at least ten pounds and preferably no greater than one hundred pounds. Lighter and heavier options may be used in some implementations. In one preferred implementation, the modular block is less than or equal to fifty pounds. This weight range provides substantial strength while remaining movable by a human worker. A modular block 100 could alternatively be suitable weight.

The side faces of a modular block 100 function to expose the coupling interface. The side faces are preferably surfaces of a modular block 100 adjacent to the extrusion face. In one implementation, the side faces are substantially flat planar surfaces with various structural features for the coupling interface. Alternatively or additionally, each modular block 100 may include defined and complimentary crevices, notches, coupling interface features, or surface profile features along the external side faces, which may promote alignment, arrangement, or other features of the blocks.

In one alternative geometric form, the modular block 100 comprises a set of surfaces that promote complimentary alignment, which functions to simplify stacking and alignment as the modular blocks 100 have a natural stacking pattern as shown in the two exemplary modular block forms in FIGS. 5A, 5B and 5C. In one implementation, at least a first side face includes a protruding structural guide and a second side face includes a defined recessed structural guide, wherein the protruding structural guide and the recessed structural guide are complimentary in shapes to promote physical mating. In one variation, the structural guides can be notches as shown in FIG. 5C. The structural guides preferably have graduated or angular surfaces which function to guide the coupling of two structural elements. The structural guides may additionally include discrete, blocking surfaces that are configured to prevent or mitigate shifting in one or more dimensions.

In another variation, the structural guides can be a latching mechanism wherein modular blocks 100 can be slid into a latched position. The latched position may be rigidly blocked from moving in one or more direction. The rigidly blocked direction of a latching notch interface can be aligned according to the intended usage. In another variation, the rigidly blocked direction of a latching notch interface can be varied between different attached modular blocks 100 so that overall, the configured block structure prevents block shifts in a number of directions/angles.

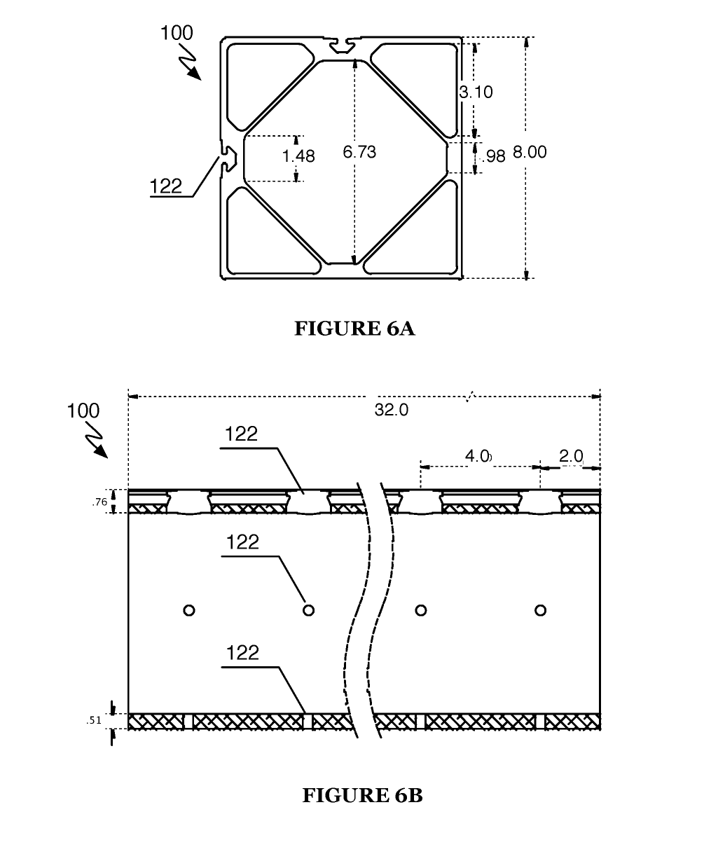

As an exemplary implementation of a modular block, a rectangular modular block 100 preferably has four side faces and two extrusion faces. The dimensions of the modular block 100 can be adjusted to a variety of dimensions. In one implementation, a cubic modular block 100 may have width and height sides measuring one foot. In another implementation, the modular block 100 has an eight inch by eight inch extrusion face with a thirty-two inch length as shown in FIGS. 6A and 6B. Preferably, the dimensions of the modular block 100 are determined by factoring in the material weight of the modular blocks 100 such that the resulting weight is suitable for human manipulation (e.g., less than 40 lbs.). Heavier modular blocks 100 may alternatively be used.

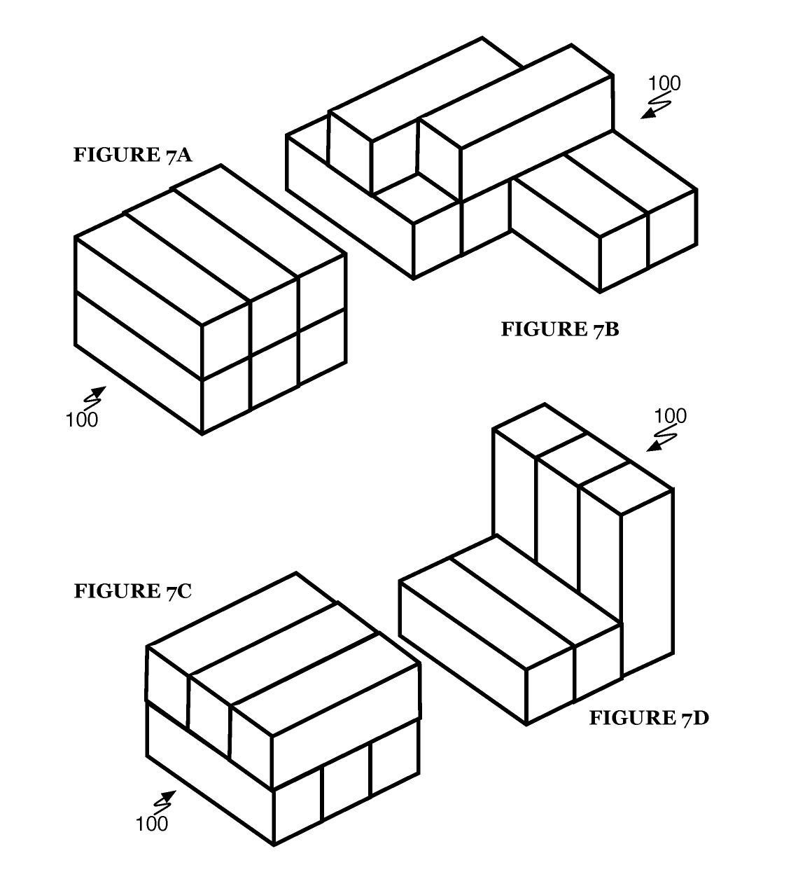

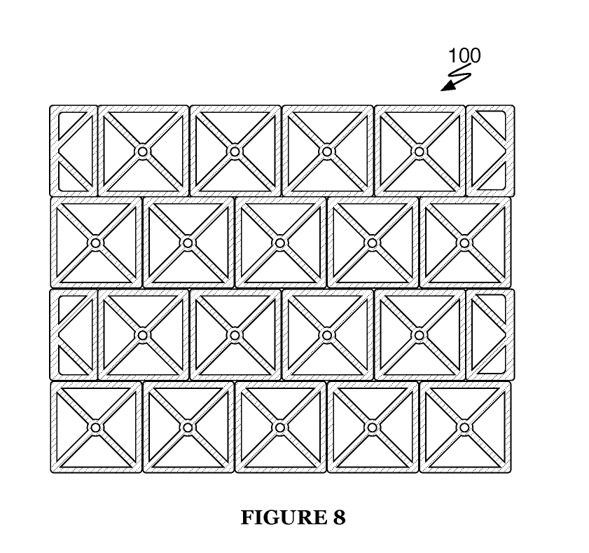

The system is preferably designed to enable customization of the configured block structure by arranging the modular blocks 100 in various directly adjacent positions. While the modular blocks may be configured in a regular patterns, which is primarily used as the exemplary configuration herein, the modular blocks can be configured in a variety of arrangements as shown in FIGS. 7A-7D. One exemplary configuration can use regular, aligned arrangement as shown in FIG. 7A. Other exemplary configurations can apply offset alignments, staggered alignment, perpendicular alignments, and/or other arrangement variations in a non-uniform manner as shown in FIG. 7B. Another exemplary configuration can use alternating perpendicular layered arrangement as shown in FIG. 7C. In a related exemplary configuration, the configuration can include perpendicularly mounted modular blocks on at least one face of a modular block as shown in FIG. 7D.

Preferably the coupling interfaces 120 of the modular blocks 100 enables configuration of block alignment in two dimensions as shown in FIG. 1. Modular blocks, when in a block configuration can be arranged in a set of aligned block positions defined across two dimensions. Other implementations may additionally enable directly adjacent positioning in different block positions defined in three dimensions or alternatively in one dimension. In one variation, the defined block positions are arranged in an edge-aligned arrangement as shown in FIG. 1 in which the edges of the blocks are aligned. In another variation, the blocks can be arranged in an offset, staggered arrangement wherein the edges of adjacent blocks are offset. A staggered arrangement can have staggered side faces and edge-aligned extrusion faces as shown in FIG. 8 and/or edge-aligned side faces.

In one variation, the block coupling interfaces 122 of the blocks can enable flexible adjacent positioning (e.g., fixturing two blocks along complimentary faces with a customized offset) or enable discretely selected adjacent positioning (e.g., fixturing two blocks along complimentary faces with one of a limited set of possible offsets). In this way a custom block offset could be arranged within a block structure. The block coupling interface may include defined external side profiles used in rigidly fastening blocks along the bordering surfaces.

The longitudinal extrusions 110 function to provide structural rigidity and strength while also managing weight of the modular block. The longitudinal extrusions 110 are preferably one or more defined cavities through the length of a modular block 100. A longitudinal extrusion cavity is preferably an internal cavity with parallel lines and defined openings on opposing faces of the modular block 100. The longitudinal extrusions 110 can additionally function to provide accessibility to fasteners or coupling mechanisms used in attaching two or more modular blocks 100 at a coupling interface.

The longitudinal extrusions 110 preferably go through the length of a modular block 100 and preferably define a through-hole. Alternative manufacturing approaches may not have the longitudinal extrusions 110 be through-holes but alternatively define inset cavities. For example, a modular block manufactured through welding, injection molding, casting, and the like may use inset cavities. As one potential benefit, the longitudinal extrusions 110 can mitigate the weight of an individual modular block 100. The longitudinal extrusions 110 additionally cooperatively define internal and external structures that promote structural support of the modular block 100. The geometric configuration of the longitudinal extrusions 110 may additionally provide the practical benefit of providing sufficient space for fastening two modular blocks 100 together.

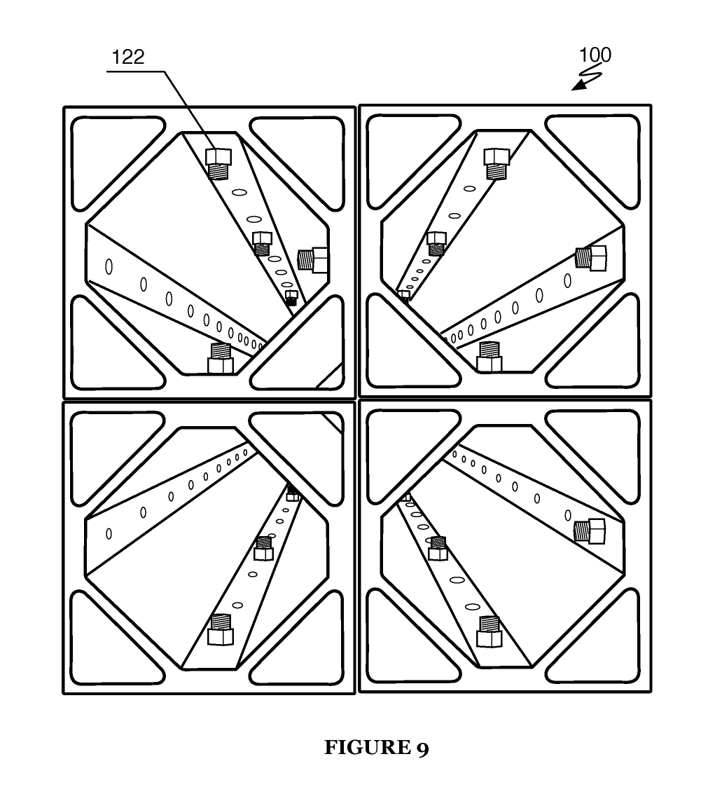

A wide variety of geometries may be used for the longitudinal extrusions 110. A diamond configuration preferably includes a defined central diamond extrusion and four defined corner extrusions as shown in FIG. 9. The diamond extrusion is preferably a substantially square extrusion rotated ninety degrees. The diamond extrusion additional includes mounting surfaces at the corners of the diamond shape that are parallel to the outer surfaces of the modular block 100.

Another approach could use an “x” configuration wherein four triangular longitudinal extrusions 110 define an internal structure in the shape of an “x” as shown in FIG. 4A. Other suitable geometric configurations may alternatively be used.

A coupling interface 120 functions as a subcomponent of a modular block 100 that is used to mechanically couple, attach, or fix various components of the system to a modular block 100. In particular, the coupling interface is used in coupling two adjacent modular blocks 100 through a block coupling interface 120. A machine tooling element 140, a bracing member 130, or other components could additionally or alternatively be attached through a coupling interface. In some variations, there may be a variety of types of coupling interfaces that are customized for different forms of physical component attachment. There may be a number of coupling interfaces 120 that are configured for rigid robust attachment, which may be designed for structural integrity such as the block coupling interfaces 122 and bracing member coupling interfaces 124. Other types of coupling interfaces 120 may be configured for more convenient coupling of none structural elements like siding, endcaps, sensors, small component attachments, and other suitable elements. Non-structural coupling interface may use different approaches to attachment (e.g., smaller bolt through holes).

The set of coupling interfaces 120 can include block coupling interfaces 122, which connect at least two modular blocks 100 together. The set of coupling interfaces may additionally include a bracing member coupling interface 124, which can enable a bracing member 130 to be mounted across two or more modular blocks 100. A coupling interface establishes a mechanical coupling between different components and as such may include fastening features in a component (e.g., a groove or hole in a modular block), fasteners, and/or other elements that facilitate establishing a structurally sound connection.

A modular block 100 may include a plurality of block coupling interfaces 122. The block coupling interfaces 122 are preferably available on at least one side face of the modular block 100. A side face may alternatively not have a coupling interface. Preferably, there are block coupling interfaces 122 on at least two adjacent side faces of a modular block 100. In this variation, a block structure can be formed by building out from one corner piece modular block 100 (e.g., by optionally building out in a horizontal direction and optionally in a vertical direction). There may alternatively be at least one block coupling interface 122 on all side faces of the modular block 100. Additionally, a side face may have multiple coupling interfaces wherein two or more blocks could be attached to one side face. A coupling interface could additionally or alternatively be integrated into the extrusion face of a block.

The block coupling interface 122 could be a uniform coupling interface where one coupling interface can be attached to any other coupling interface. Alternatively, the coupling interface could be a complimentary/paired coupling interface system where a first type coupling interface (e.g., a male interface) attaches to a corresponding second type of coupling interface (e.g., a female interface).

The block coupling interface 122 may additionally or alternatively include a set of defined and complimentary profile features that promote alignment and arrangement of the blocks.

The block coupling interfaces 122 can utilize any suitable type of fastening system such as a bolt system, a latching mechanism, and the like.

In one implementation, the block coupling interface 122 comprises at least one defined bolt through-hole on one side face of a modular block 100. Preferably, coupling interfaces of a modular block include a set of defined bolt through-holes on different side faces of the modular block. A block fastener is preferably used to secure two modular blocks through engagement with the through-holes. The bolt through-holes of two modular blocks 100 are preferably aligned and then a bolt or other suitable fastener is used in semi-permanently attaching the two modular blocks. 100. A block fastener when in an engaged mode assisting in connecting two modular blocks preferably extends through defined bolt through-holes of two adjacent modular blocks. A block fastener can be bolt, screw, bolt, washer, nut, and/or other suitable fastening elements can be used.

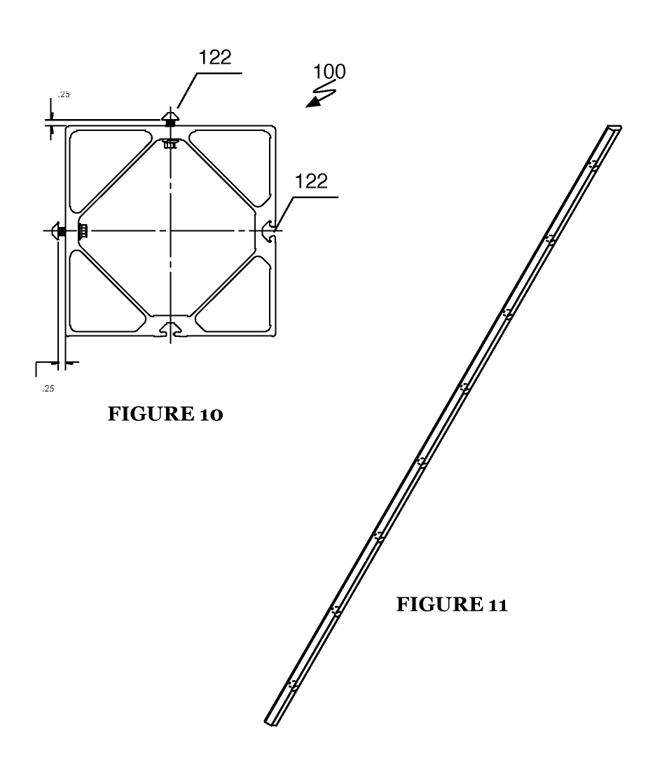

In another implementation shown in FIG. 10, the block coupling interface 122 utilizes a block coupling interface 122 that includes a defined bolt through-hole on a first face of a first modular block, a block coupling interface 122 defining a t-nut access slot on a second face of a second modular block, a t-nut, and a set of bolts. When the two modular blocks are rigidly coupled, the t-nut can be positioned within the defined t-nut access slot and the bolt or other suitable fastener can be inserted through the bolt through-hole and engaged with the t-nut. The t-nut access slot can additionally facilitate interfacing with t-nut compatible systems.

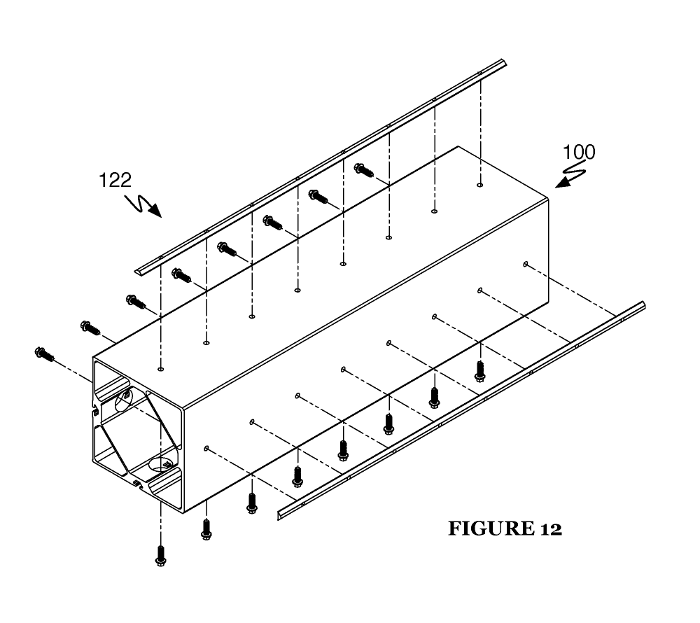

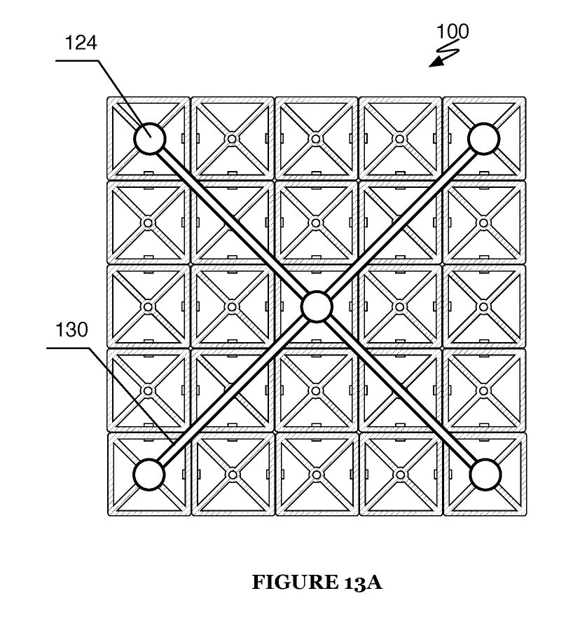

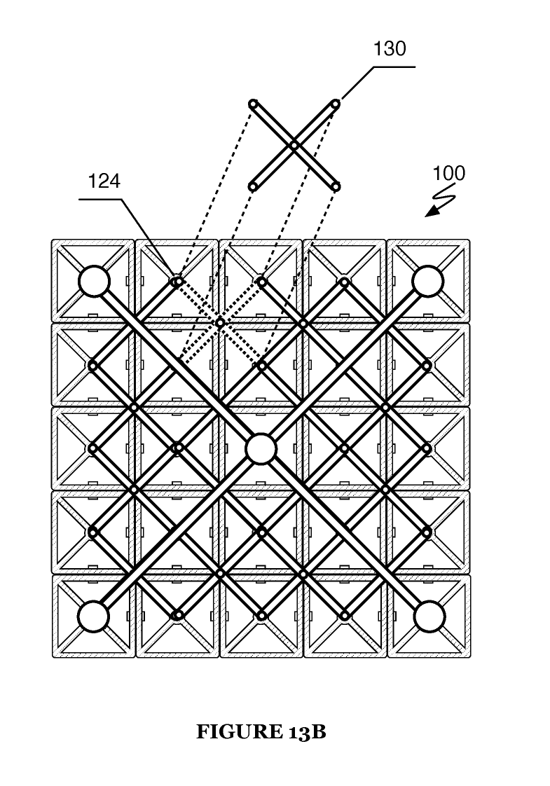

The t-nut is preferably a solid piece with a set of threaded bolt holes as shown in FIG. 11. The defined t-nut access slot enables a t-nut to be inserted along the axis of extrusions and provides fastener access to the t-nut. The access to the t-nut can additionally define a through-hole in the second side face, which can additionally enable a bolt to be more easily fastened to the opposite side as shown in FIG. 12. When fastening the first modular block 100 to the second modular block: the first and second faces of the modular blocks 100 are aligned to be adjacent; the t-nut is inserted into the t-nut slot; and bolts are fitted through the through hole and screwed into the t-nut. A set of bolts may be used along multiple points. Additionally, a through-hole on the side face opposing the first face may enable easier access to the bolt.

Other block coupling interface approaches may be used. In one variation, the system additionally includes a latching mechanism that can easily be fitted into the block coupling interfaces 122 of two adjacent blocks and then locked into place. A latching mechanism can be used to rigidly fasten a set of modular blocks 100 into an arrangement. When disassembling the block structure, the latching mechanism may also be easily opened to separate the two modular blocks 100. The latching mechanism can be specialized bolt system (e.g., fast fastening nut), spring-loaded, include a rotating latch or locking element, employ a cam, or use any suitable mechanism. The latching mechanism can be a distinct element. Alternatively, the latching mechanism may be integrated into the block coupling interface 122. In one variation, the block coupling interfaces 122 include a male and/or female latching mechanism.

Preferably, the longitudinal extrusions 110 additionally include exposed internal access to the coupling interfaces such that a fastener or other fastening mechanism can be engaged. The exposed internal access is preferably sized for fastener and/or tool access and usage. For example, a bolt through-hole may extend through to a defined cavity in the longitudinal extrusion 110. A tool or hand can access and then engage a fastener element like a bolt, nut, or other element to engage the fastener and restrict motion of connected modular blocks 100. As one point of access to the coupling interfaces and/or the latching mechanism may remain fully accessible during assembly and use. Especially for two-dimensional block configurations, the latching mechanisms used in a coupling interface can be accessible without requiring disassembly of the blocks. In this way, the fastening process can be loosely engaged during assembly, and then tightened to specifications after the blocks are in place. Maintenance of the structure could also be performed on all the latching mechanisms since they are fully exposed. Additionally, disassembly can be easily performed.

A modular block 100 may additionally include a set of bracing member coupling interfaces 124. A bracing member coupling interface 124 is preferably exposed on the extruded face of a modular block 100. The bracing member coupling interface 124 can enable a bracing member 130 to be attached to the modular block 100. In an engaged mode, a bracing member preferably rigidly attaches across the extrusion faces of a subset of modular blocks through the bracing member coupling interfaces 124. The bracing member 130 may additionally be fastened to another modular block, which may be an adjacent modular block 100 or a non-adjacent modular block 100. The bracing member 130 can provide alternative structural support to a configured block structure. In one variation, the bracing members 130 are bars or support beams that extend from one point on a modular block 100 to another modular block 100. The bracing members 130 may be used in coupling adjacent modular blocks 100. In a preferred implementation, the bracing members 130 may include a latching mechanism so that the bracing member 130 can be inserted into place than easily latched, tightened, or otherwise engaged. Alternatively, bolts or other traditional fastening mechanisms may be used. The bracing members 130 could alternatively be used in coupling across non-adjacent modular blocks 100 as shown in FIG. 13A. In another variation, a mixture of adjacent and non-adjacent bracing member systems can be used as shown in FIG. 13B. In another variation, the bracing member 130 can be a structural sheet, which can additionally function to seal exposed cavities. Alternatively, an endcap can be used to cover the exposed cavities.

A number of various optional elements may be used in connection with and/or included in a modular block 100 or block configuration.

The system may include block endcaps, which function to cover exposed cavities of a modular block 100. The endcaps may attach to an extrusion face. Similarly, the system may include shielding that can be used to cover various surfaces of a block configuration. The shielding may be used to make one or more surfaces of a block configuration a continuous surface, which could be useful in making the block configuration water tight creating a container, or serving any suitable function.

The modular blocks 100 can additionally include one or more defined access channels, which function to enable running various lines through a modular block 100. In a block configuration, the defined access channels of the modular blocks 100 preferably enables a line to be run into a channel port, through a set of modular blocks 100, and out of a channel port at a particular modular block 100. The access channels can be configured in a modular block 100 to establish an interconnected channel network so that different lines can be routed to different select locations. The access channels can be used for running power lines, fluid lines, communication/data lines, which may be used for sensors, tooling elements, and the like.

When assembled, the system acts as a configured block structure. The block structure as described above can be used for a variety of applications. In a preferred implementation, the block structure is used as a machine bed for one or more machine tooling elements 140. The machine tooling elements 140 may be mounted or coupled directly to one or more modular blocks 100. The block configuration preferably serves as the base wherein the block configuration rests on the ground. The block configuration may additionally be rigidly attached to the ground or another supporting structure like a general purpose casting designed to engage with a block configuration. Alternatively, the system may include machine tool adapter pieces to enable the machine tool elements to be physically coupled to one or more modular blocks 100. In one variation, and machine tooling elements 140. The block coupling interface 122 may expose a convenient mounting surface for various machine tooling elements 140. The block coupling interface 122 defining a t-nut access slot can enable the same t-nut and bolt approach to be used for mounting machine tooling elements 140. The types of machine tooling elements 140 can include a wide variety options.

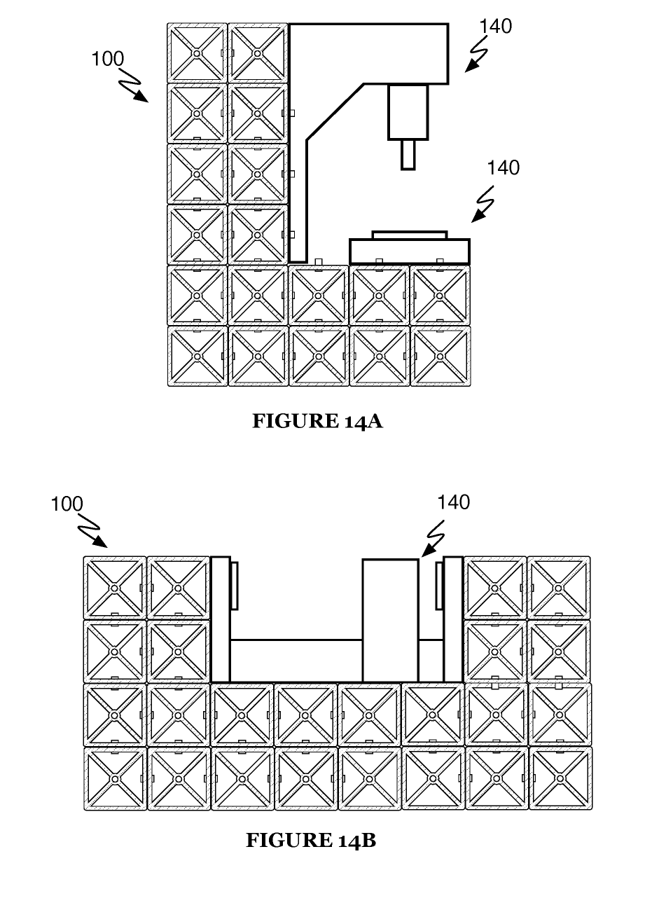

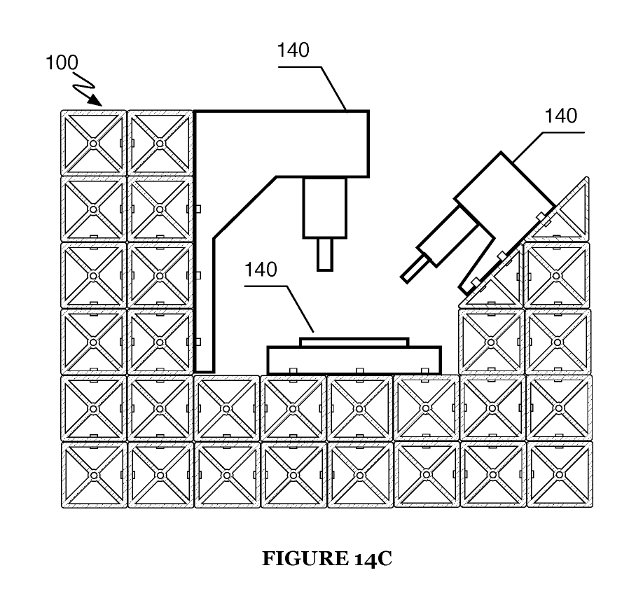

In one example shown in FIGS. 3 and 14A, the system can include a vertical mill or CNC machine tooling element and a worktable. This can preferably be used in making a multi-axis CNC milling device. A configured block structure preferably includes a base feature and a column feature. A worktable can be attached to the base feature, and the tooling element (e.g., the mill) can be attached to the column that extends vertically above and adjacent to the base feature.

In another exemplary variation, the system can include a machine tooling elements 140 of a lathe that are attached within a block structure. In one example, the block structure comprises a base feature and two column features. A lathe bed can be attached to the base feature, and a headstock system and tailstock systems could be attached to different column features as shown in FIG. 14B.

As described, the system can be used in building custom machine types for various applications. In particular, various combinations and configurations of machine tooling elements 140 can be used in combination. As one aspect, multiple machine tooling elements 140 could be mounted at different positions and/or orientations. In particular a multi-axis machining center can be created by coupling two or more machining elements (e.g., subtractive machining elements like a milling element) in a multi-axis tooling configuration. Multi-axis tooling configuration preferably has toolings approaching a worktable from different directions and/or at different orientations. As shown in FIG. 14C, a customized CNC milling device could be constructed by including multiple machine tooling elements 140 mounted to different features of the configured base structure. A mill tooling element could be mounted to a first column feature and a second milling tooling element could be mounted to a second column feature. Other hybrid/custom machines could be configured through the system. For example, various subtractive manufacturing elements, material handling elements, additive manufacturing elements, material forming, and/or other elements could be combined in highly customized arrangements. These configurations could be customized and reconfigured for particular manufacturing processes.

Any suitable industrial machine may alternatively be constructed using the modular blocks 100.

Additionally, machine tooling elements can be exchangeable, and the system components reconfigured for use as different machines. The system may be configured for a first assembled configuration with a first machine tooling element; and then a second machine tooling element that, in a second machine tool mode, is coupled to a second base assembled configuration. The first and second assembled configurations may be different block structures.

The system may additionally include calibration sensors that integrate with a control system of a machine tooling element 140. The calibration sensor can be used to direct compensation for any imprecision of the block structure and/or structural changes or settlement over time. The system can include a calibration operation mode in which, the machine tooling element 140 is updated to. This can be used to account for changes in alignment and/or orientation of different machine tooling elements 140. For example, the alignment and relative orientation of attached mill and a workbench could be measured, and the respective control systems updated to compensate for measured alignment and/or orientation.

### Method

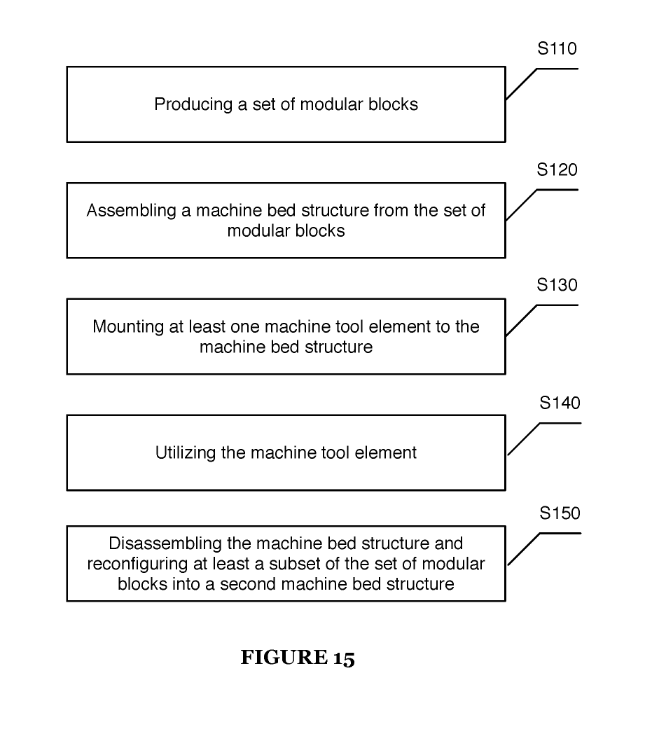

As shown in FIG. 15, methods for a configurable industrial machine of a preferred embodiment can include one or more of: producing a set of modular blocks S110, assembling a machine bed structure from the set of modular blocks S120, mounting at least one machine tool element to the machine bed structure S130, and/or utilizing the machine tool element S140. The methods may additionally include disassembling the machine bed structure and reconfiguring at least a subset of the set of modular blocks into a second machine bed structure S150. The methods are preferably implemented in connection with the system described above. The various methods may be employed in the manufacture or production of the above system, manufacture or production of a machine utilizing the modular block system, in the use and application of the machine, in the ongoing operation of a machine built with the modular block system, and/or in the reconfiguration and reuse of the system components for alternative applications.

Block S110, which includes producing a set of modular blocks, functions to manufacture a set of structural components that can be assembled into a machine bed. A resulting modular block is preferably substantially similar to the modular block described above. Alternative design variations may be used. Producing a set of modular blocks preferably includes extruding a base block structure and from the base block structure producing a set of substantially similar modular blocks. More specifically, producing a set of modular blocks comprises extruding a length of material with a modular block extrusion profile, cutting the length of material into at least one modular block unit, and/or applying secondary processing. The secondary processing may be performed when the material is a modular block unit and/or a length of material. The secondary processing may include milling or otherwise creating various coupling interface features (e.g., block coupling interface features and/or bracing member coupling interface features).

For example, an aluminum extrusion process can be used to extrude a diamond extrusion profile as described above. From that extruded piece, multiple individual blocks can be cut. The length of the modular block pieces can be easily adjusted to accommodate a set of modular block varieties or to customize the modular block length for a custom project. Secondary manufacturing processes are preferably performed on the cut modular block piece to complete the modular block. For example, a set of through-holes and hole threading may be performed to complete various elements of the coupling interfaces. Other manufacturing processes may alternatively be used. For example, a modular block may be machined, welded together from multiple parts, constructed from multiple parts, or formed in any suitable manner.

Block S120, which includes assembling a machine bed structure from the set of modular blocks, functions to use the basic elements of the system to create a machine bed. As one aspect of the modular block approach, the components of the system can be easily transported and moved. The modular blocks can be manually arranged and assembled without dependence on heavy machinery or equipment. Assembling a machine bed structure can include arranging at least two modular blocks and attaching a first modular block to a modular second block through the block coupling interfaces of the first and second modular blocks. In one variation, blocks may be incrementally arranged and attached. In another variation, the modular blocks may be arranged into a substantially final configured block structure and then attached.

Arranging two modular blocks preferably includes aligning coupling interfaces of two blocks. The modular blocks preferably support directly adjacent placement of modular blocks. Offset or staggered alignment may be available with multiple block coupling interface options on one side face. In some variations, the block coupling interface may support variable alignment. In some variations of modular blocks, structural guide features may engage between the blocks during arrangement.

Attaching the modular blocks functions to fixture, latch, bind, or otherwise connect the modular blocks through the coupling interfaces. For block coupling interfaces using a bolt mechanism, attaching the modular blocks can include receiving a bolt through a bolt through-hole of two adjacent coupling interfaces and engaging the bolt (e.g., tightening a washer and nut). For block coupling interfaces utilizing a t-nut access slot, fastening the first modular block to the second modular block can include adjacently aligning the first and second faces of the modular blocks are aligned; receiving a t-nut into a defined t-nut slot of the second face; mechanically coupling a bolt inserted through a through-hole of the first face and second face into the t-nut A set of bolts may be used along multiple points in the t-nut. This process is preferably repeated for each modular block attached to a second modular block until the basic structure is formed.

In one variation, the assembling of a machine bed structure can include receiving a block structure description and generating a modular block configuration model, which functions to recommend a block structure and modular block arrangement. The recommended block structure preferably accounts for structural requirements as specified in the block structure description. For example, a user wanting to setup a new machine can provide various parameters of the desired machine, and a modular block configuration model can direct the modular block types (e.g., if multiple classes or types of modular blocks are offered), arrangement, attachment specifications (e.g., bolt torque tightness levels), machine tool attachment instructions, and the like. The block structure description preferably describes different aspects of intended use of the machine. The block structure description can include operating parameters such as forces, weights, machine tool types, machine tool uses, and/or other descriptors. In one implementation, the block structure description is a set of manually entered configuration properties. For example, an application form could be used to collect the configuration properties. In another implementation, the block structure description can be retrieved from a machine model. For example, a user could create a virtual representation of the machine and a modular block configuration model can be generated from that. In another example, a menu of machine tool types could be displayed, and a user could select a machine tool option that best describes their intended use.

In some variations, assembling a machine bed structure can include a secondary process of mounting bracing members. The bracing members are preferably mounted or otherwise attached to at least one extruded face of a modular block. More preferably the bracing member is mounted between at least two extruded faces of a module block. The bracing member may provide structural integrity to the structure. The bracing member may alternatively or additionally provide solid shielding. For example, sheet metal can be mounted to sides of the block structure.

Block S130, which includes mounting at least one machine tool element to the machine bed structure, functions use the machine bed structure as a solid base for manufacturing processes. The machine tool element could be a milling device, a lathe-based device, a drill, an extrusion tool, an assembly device, other subtractive manufacturing systems, other additive manufacturing systems, other material handling systems, and/or any suitable machine tools. The machine tool could be manually controlled by a CNC-based device, manually operated, or controlled in any suitable manner. Additionally, other components of a machine such as a worktable, a coolant fluid system, or any suitable systems or machine tool elements may be mounted to the bed structure. Because of the flexibility in the geometry of the configured block structure, various machine tool configurations can be supported. In some cases, the particular machine tool configuration may be highly customized for a particular manufacturing process or application.

Block S140, which includes utilizing the machine tool element, functions to use the machine tool for its intended purpose. During use, the machine bed structure preferably provides the structural support.

In one variation, utilizing the machine tool element can include calibrating alignment and orientation of the configured block structure, which can include reading calibration sensors at a set of locations of the configured block structure and updating control system of a machine tool element. The calibration process preferably corrects for misalignment or of the base structure. As the base structure is a construct of multiple parts, misalignment and orientation may not be uniform across the whole structure. Multiple locations or regions can be calibrated. Calibration can preferably be periodically performed to address changes in the base structure during use. The calibration sensors can include digital accelerometers, gyroscopes, imaging devices, and the like.

In another variation, the method may additionally include generating a maintenance report. This may be performed in connection with calibrating alignment and orientation. Alternatively, a maintenance report may be based on the intended use, measured usage, type of block structure, and/or other factors. The maintenance report preferably generates a recommendation of when to perform maintenance and the type of maintenance to perform. For example, a maintenance report may generate instructions on how to check the fasteners at various locations of the block structure.

Block S150, which includes disassembling the machine bed structure and reconfiguring at least a subset of the set of modular blocks into a second machine bed structure, functions to leverage the flexibility of the system to reuse the components for other uses. As opposed to a cast bed, the method enables a usable machine bed to be repurposed for other uses. In one variation, a machine bed structure need not be fully disassembled. Parts of the machine bed structure can be disassembled while other parts may be added to the machine bed structure. For example, converting a mill to a lathe may reuse the base part of the bed alter the mounting portions of the machine bed structure.

Disassembling is preferably the reverse process of assembling. Bracing members can be disconnected from the bracing member coupling interfaces. And blocks can be decoupled from each other by disengaging the block coupling interface connections. For example, the bolts can be removed from the t-nut and the t-nut removed from the t-nut access slot. Once removed, the individual components can be reused in any suitable manner. Since the modular block system is made of a limited set of modular block types, they can be easily be repurposed.

As a person skilled in the art will recognize from the previous detailed description and from the figures and claims, modifications and changes can be made to the embodiments of the invention without departing from the scope of this invention as defined in the following claims.

We claim:

1. An industrial manufacturing system comprising:
a set of modular blocks, wherein each module block comprises a defined longitudinal extrusion cavity and a set of coupling interfaces;
wherein in a first assembled configuration, at least two modular blocks are rigidly coupled at opposing coupling interfaces of the at least two modular blocks.

2. The system of claim 1, further comprising a machine tooling element; and wherein, in the first assembled configuration, the machine tooling element is coupled to at least one modular block.

3. The system of claim 2, wherein the machine tooling element is a computer numerically controlled mill tooling element; and further comprising a worktable that is coupled to at second modular block.

4. The system of claim 2, wherein the machine tooling element is selected from the set of machine tooling elements comprising: a mill tooling element, a lathe tooling element, an injection molding tooling element, and a material handling element.

5. The system of claim 1, wherein the coupling interfaces comprises a set of defined bolt through-holes on a set of side faces of the modular block; and further comprising a set of block fasteners wherein each of the set of block fasteners extends through defined bolt through-holes of two adjacent modular blocks when in the first assembled configuration.

6. The system of claim 5, wherein the defined longitudinal cavities expose internal tool access to the bolt fasteners.

7. The system of claim 1, wherein the modular blocks in the first assembled configuration are arranged in aligned block positions defined across two dimensions.

8. The system of claim 7, wherein the aligned block positions are in a staggered arrangement.

9. The system of claim 1, wherein each modular block of the set of modular blocks has a weight greater than ten pounds and no more than one hundred pounds.

10. The system of claim 9, wherein each modular block of the set of modular block has a length in the direction of extrusion of at least twelve inches, a width and height along the extrusion face of at least six inches.

11. The system of claim 1, wherein each modular block of the set of modular blocks is extruded aluminum with a set of machined fastening features on the coupling interfaces.

12. The system of claim 1, wherein each module block is an extruded material with a plurality of defined longitudinal extrusion cavities.

13. The system of ii, wherein each modular block wherein the set of defined longitudinal extrusion cavities comprises a defined central diamond cavity and four defined corner cavities.

14. The system of claim 1, further comprising at least one bracing member that rigidly attaches across the extrusion faces of a subset of modular blocks when the bracing member is in an engaged mode.

15. The system of claim 1, wherein the set of coupling interfaces comprises: a coupling interface with a defined bolt through-hole on a first face of the first modular block, a second coupling interface with a defined t-nut access slot on a second face of the second modular block; the system further comprising a t-nut and a bolt.

16. A manufacturing machine comprising:
a set of modular blocks, wherein each modular block comprises a defined longitudinal cavity and a set of coupling interfaces; and
machine tooling element coupled to a configured block structure assembled from the set of modular blocks; and
wherein the base comprises the set of modular blocks in an aligned grid and rigidly coupled with a set of block fasteners at a set of coupling interfaces of adjacent modular blocks.

17. The manufacturing machine of claim 16, wherein the machine tooling element is a computer numerically controlled mill tooling element; and further comprising a worktable that is coupled to at least one modular block.

18. The manufacturing machine of claim 16, wherein the machine tooling element is selected from the set of machine tooling elements comprising: a mill tooling element, a lathe tooling element, a plotter tooling element, an injection molding tooling element, and a material handling element.

19. The manufacturing machine of claim 16, further comprising a second machine tool element, that in a second machine tool mode is coupled to a second base assembled from the set of modular blocks in a configured block structure that is different from the first base.

20. The manufacturing machine of claim 16, further comprising a second machine tooling element coupled to the configured block structure, wherein the first and second machine tooling elements are oriented in a multi-axis tooling configuration.
